(19) United States
(12) Patent Application Publication
(10) Pub. No.: US 2005/0165500 A1
(43) Pub. Date: Jul. 28, 2005

(54) Use of massively multi-player online games for computationally hard problems

(75) Inventors: Charles Vaughn Rankin, Austin, TX (US); Michael Richard Cooper, Austin, TX (US)

Correspondence Address: Kelly K. Kordzik, 400 North Ervay Street, P.O. Box 50784, Dallas, TX, 75201, US

(73) Assignee: International Business Machines Corporation, Armonk, NY (US)

(21) Appl. No.: 10/763,106

(22) Filed: Jan. 22, 2004

(51) Int. Cl. G06F 17/00

(52) U.S. Cl. 700/91

(57) ABSTRACT

Systems and method of modeling computationally complex problems are provided. A first set of physical entities is mapped to a first set of entities in a massively multiplayer online game (MMOG). A second set of physical entities is mapped to a second set of entities in the massively multiplayer online game. Each player in the massively multiplayer online game manipulates members of the second set of entities to interact with the first set of entities in accordance with a quest defined in the massively multiplayer online game. A subset of members of the second set of physical entities corresponding to members of the second set of entities in the massively multiplayer online game having an outcome exceeding a preselected outcome is selected.

### TECHNICAL FIELD

The present invention relates to the field of Massively Multi-player Online Games (MMOG), and more particularly to using an MMOG for computationally hard problems.

### BACKGROUND INFORMATION

A Massively Multi-player Online Game (MMOG) is an online game where a lot of people from all over the world play and interact with one another. One example of an MMOG is called Ultima Online. Ultima Online is a virtual, fantasy world where a person plays as an adventurer in this fantasy world. Typically, the adventurer is “created” by the player in a character creation screen. There the player may select from a number of characters, e.g., character good at archery and tailoring. Once the player selects the character, the player may fight dragons, make weapons, team up with fellow adventurers to brave deadly monster lairs. There may be hundreds, sometimes thousands of players, playing in the same virtual world. When a person finishes playing, the MMOG continues. That is, the virtual world continues. When the person returns to play, the virtual world may appear to have changed based on the actions of the other players in the online game.

One of the differences with MMOGs in comparison to other types of online games or arcade games is the interaction between other players. By interacting with other players, various actions may be attempted that may not have been attempted while playing alone. Some of these actions, resulting from the interaction with other players, may be unpredictable and hence may have unforeseen results. These unforeseen results may be beneficial. For example, by a combination of unpredictable actions, the players may be able to kill a monster in the virtual game. This unpredictable behavior, as exhibited in MMOG, may not be currently used to a large extent to solve real problems, e.g., cure for a viral strain.

For example, in the medical field, biologists, micro-biologists, pharmacologists, etc., may use various tests to study and develop drugs and medicinal preparations to thwart or effectively eradicate deadly viral and bacterial strains. However, these tests are typically confined to an individual or a small team using known techniques to test various substances on viral and bacterial strains and study the resulting behaviors of the strains. If, however, a greater number of testing variations were used, e.g., a greater number of substances and various combinations of substances, then there may be an increased chance in developing drugs to effectively eradicate deadly viral and bacterial strains. Further, some discoveries occur by accident. By using unpredictable behavior in a greater number of testing variations, there may be an increased chance in developing drugs to effectively eradicate deadly viral and bacterial strains.

If the unpredictable behavior of thousands of people, as exhibited in MMOGs, could be used to solve real problems, e.g., cure for a viral strain, then there may be a scientific/academic benefit, e.g., increased chance in developing drugs to effectively eradicate deadly viral and bacterial strains.

Therefore, there is a need in the art to adapt and use MMOGs for solving computationally hard problems.

### SUMMARY OF THE INVENTION

The aforementioned needs are addressed by the present invention. Accordingly, there is provided a method of modeling computationally complex problems. A first set of physical entities is mapped to a first set of entities in a massively multiplayer online game (MMOG). A second set of physical entities is mapped to a second set of entities in the massively multiplayer online game. Each player in the massively multiplayer online game manipulates members of the second set of entities to interact with the first set of entities in accordance with a quest defined in the massively multiplayer online game. A subset of members of the second set of physical entities corresponding to members of the second set of entities in the massively multiplayer online game having an outcome exceeding a preselected outcome is selected.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates in flow chart form a methodology for modeling computationally hard problem in accordance with an embodiment of the present invention;

FIG. 2 illustrates, in block diagram form, a data processing system which may be used in conjunction with the methodologies incorporating the present inventive principles.

### DETAILED DESCRIPTION

In the following description, numerous specific details are set forth to provide a thorough understanding of the present invention. For example, particular messaging protocols may be referred to, however, it would be recognized by those of ordinary skill in the art that the present invention may be practiced without such specific details, and in other instances, well-known circuits have been shown in block diagram form, in order not to obscure the present invention in unnecessary detail. Refer now to the drawings wherein depicted elements are not necessarily shown to scale and wherein like or similar elements are designated by the same reference numeral through the several views.

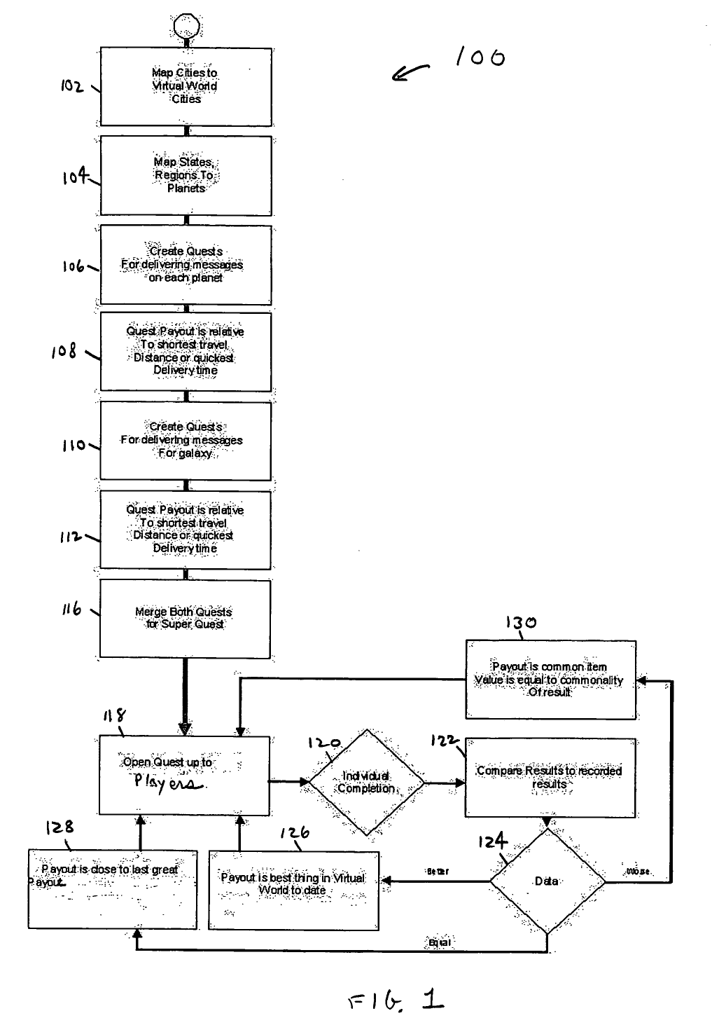

One such problem of computational complexity is the so-called travelling salesman problem. The problem is to find the minimum total cost of travel between a finite number of geographic locations with each being visited, and having a known cost of travel between each pair. A flowchart for a methodology 100 for modeling the travelling salesman problem via a MMOG is illustrated in FIG. 1.

In step 102, cities are mapped into virtual world cities. Likewise, in step 104, states and regions are mapped to virtual-world planets. In step 106, a quest is created for delivering messages on each planet.

A quest payout is mapped to the shortest travel distance (or equivalently, quickest delivery time, step 108. A quest payout is a virtual-world object of value. That is an object in the virtual world, that players seek to maximize.

In step 110 a quest for delivering messages to galaxies is created. A corresponding quest payout is mapped to the shortest travel distance (or, equivalently, travel time), step 112.

In step 114, the quests created in steps 106 and 110 are merged into a superquest, step 116. The quest is open to players in the MMOG in step 118.

As an individual player completes the superquest, step 120, that player's actions are logged and results are compared with the previous results, that is, the results of players having previously completed the quest, step 122. In step 124, it is determined if the player's result is better, worse or the same than the previous results.

If the result is better, the payout to the player is the best valued object in the virtual world at the current time, step 126. This provides the incentive for players to optimize his or her result. Process 100 returns to step 118, to continue play.

If the result is equal to the prior results, the payout to the player is close to the last great payout, step 128. The incentive to players is to get others to achieve this so they can start improving.

If the result is worse that previous results, the payout to the player is a common object whose value in the virtual world is equal to the commonality of the result, step 130.

Note that the results logged in step 120 as players complete the quest, provide a sequence of the mapped entities, and the transitions therebetween, in the virtual world of the MMOG. The set of transitions provides an algorithm design for the physical model problem solution, essentially by the inverse of the mapping from the physical world to the virtual world. Selected or identified subsets of the results logged corresponding to entities in the physical world inversely mapped from the entities in the virtual world having payouts exceeding a preselected threshold may be electronically sent to an external, “observer” data processing system for analysis. An external or remote data processing system is one that is external to the game itself.

Although the present inventive principles have been illustrated using in the context of a MMOG model for the travelling salesman problem, by defining other mappings the methodology may be applied to the MMOG modeling of other problems physical world problems. For example, by mapping creatures in a MMOG to viral and bacterial strains, and mapping the users' characters and equipment choices to pharmaceutical agents and reagents, the interaction of the pathogens and the reagents may be modeled. In this embodiment, the data logged as players complete the quest may provide a set of experimental protocols for testing the agents/reagents against the pathogens.

Similarly a mapping of optimization constraints onto the objects and creatures in a MMOG and logging combinations that are created by the players provides an algorithm design for quantitative methods of business (QMB) problems.

The aforementioned methodology may be applied to other problems in the physical world. These include behavioral investigations, sociological investigations, geopolitical investigations and economic investigations. In behavioral investigations, a MMOG is used to investigate the behavioral tendencies of certain segments of the population. One example would be to study how criminals relate to the different roles in a game like Ultima Online or the upcoming Star Wars Galaxies where there is a broad cross-section of trades/jobs that can be undertaken. A hopeful outcome might be to be able to correlate recalcitrant tendencies to roles taken in-game. Sociological investigations are somewhat similar to behavioral studies. However, in this case, the participants are a “normal” cross-section of the populace. Then, you introduce sociological dilemmas and see how the populace reacts. For example by adding/removing gangs/guilds, the shift of people to new areas may be observed or anything that looks into the interrelationships of groups of people. In economic investigations, the idea is to examine/investigate the behavior of large groups of “real” people under various economic forces. For example, if you drive up the price of onegood/service, how does that affect the other goods/services. This is already studied today without the use of VWs or MMOGs, however, the use of these technologies allows two main benefits. One, you can artificially induce changes in the “world”, whereas you have to investigate things after the fact in the real world. Two, it allows you to study economic niches that are just beginning or are being considered for creation. Stock market simulations would be another very narrow but potentially prolific example. Geopolitical investigations are similar to economic investigations but is geared at political situations. The same two benefits are prevalent here. An example, that mixes with economic investigations, would be to influence the exchange rates of various currencies to see how political affiliations change. Similarly, you could create embargoes (etc.) to see the potential ramifications.

Note, most of the aforementioned topics have several subtopics. Presumably these types of problems could be added relatively dynamically by adding new creatures, equipment, etc.

Additional applications include traffic simulations, racing/driving/car manufacturing simulations, genetic/zoologic simulations and military investigations and terrorism. In traffic simulations, various traffic corridors may be rerouted to see how “real people” create new routes, or in road maintenance exploration, see what happens when specific areas of a geographic region are “closed”. In racing/driving/car manufacturing simulations let users pick various configurations and see how they “rate”. In genetic/zoological simulations/investigations users manipulate genetic settings and introduce the creations into the “wild” to examine how ecological niches behave. Similarly, in ecological investigations. various user actions are examined with respect to how they affect the “environment”. In military investigations, new troop types are introduced to allow users to determine best configurations of troops for different military situations. Terrorism investigations simulate how a VW/MMOG populace handles and manages terroristic behavior and how the terrorists modify their behavior correspondingly.

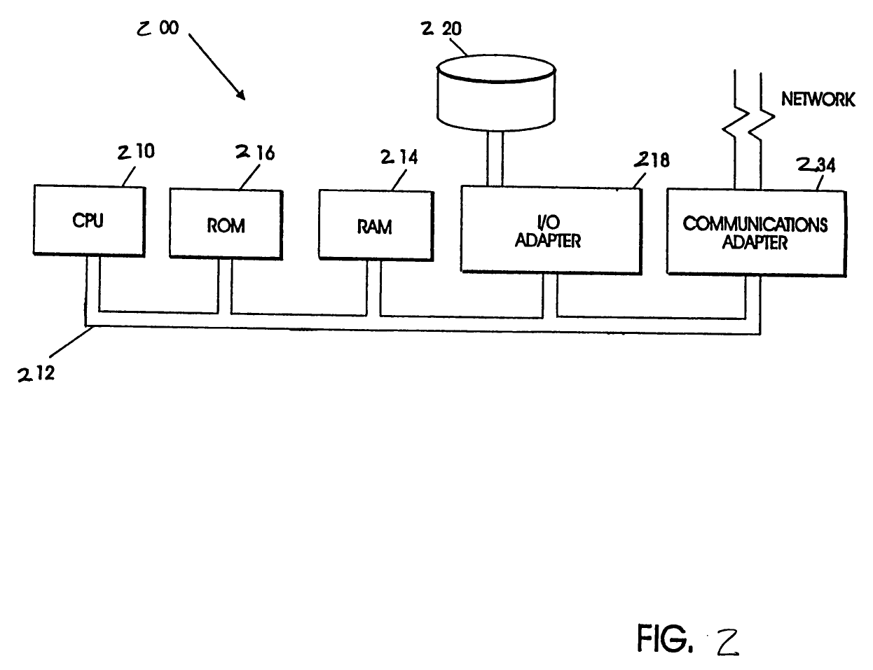

FIG. 2 illustrates an exemplary hardware configuration of data processing system 200 in accordance with the subject invention. The system in conjunction with the methodologies illustrated in FIGS. 1 may be used to model computationally hard problems in accordance with the present inventive principles. Data processing system 200 includes central processing unit (CPU) 210, such as a conventional microprocessor, and a number of other units interconnected via system bus 212. Data processing system 200 also includes random access memory (RAM) 214, read only memory (ROM) 216 and input/output (I/O) adapter 218 for connecting peripheral devices such as nonvolatile storage units 220 to bus 212, user interface adapter 222 for connecting keyboard 224, mouse 226, trackball 232 and/or other user interface devices such as a touch screen device (not shown) to bus 212. System 200 also includes communication adapter 234 for connecting data processing system 200 to a data processing network, enabling the system to communicate with other systems, and display adapter 236 for connecting bus 212 to display device 238. CPU 210 may include other circuitry not shown herein, which will include circuitry commonly found within a microprocessor, e.g. execution units, bus interface units, arithmetic logic units, etc. CPU 210 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 214 of one or more computer systems configured generally as described above. These sets of instructions, in conjunction with system components that execute them may model computationally hard problems as described hereinabove. Until required by the computer system, the set of instructions may be stored as a computer program product in another computer memory, for example, in nonvolatile storage unit 220 (which may include a removable memory such as an optical disk, floppy disk, CD-ROM, or flash memory) for eventual use in the nonvolatile storage unit 220). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

1. A method of modeling computationally complex problems comprising:
mapping a first set of physical entities to a first set of entities in a massively multiplayer online game;
mapping a second set of physical entities to a second set of entities in the massively multiplayer online game, wherein each player in the massively multiplayer online game manipulate members of the second set of entities to interact with the first set of entities in accordance with a quest defined in the massively multiplayer online game;
identifying a subset of members of the second set of physical entities corresponding to members of the second set of entities in the massively multiplayer online game having an outcome exceeding a preselected outcome; and
sending results of the quest and the identified subset of members of the second set of physical entities to a remote data processing system for analysis.

2. The method of claim 1 further comprising logging each interaction of the members of the first and second sets in response to player manipulations and corresponding outcomes of said quest of each of the interactions.

3. The method of claim 2 wherein said subset of members of the second set of physical entities comprises a sequence of second entities selected from an output of said logging step, and wherein a physical model problem solution comprises said sequence of second entities.

4. The method of claim 3 wherein a set of transitions between members of said sequence of said second entities comprises an algorithm for said physical model problem solution.

5. The method of claim 1 wherein said subset of members of the second set of physical entities defines a set of a set of experimental protocols for testing against a subset of said first set of physical entities wherein said subset of said first set of physical entities comprises an inverse mapping of members of the second set of entities in the massively multiplayer online game having an outcome exceeding a preselected outcome.

6. The method of claim 5 wherein:
said first set of physical entities comprises pathogenic organisms;
said first set of entities in a massively multiplayer online game comprises antagonists in said massively multiplayer online game;
said second set of physical entities comprises pharmaceutical agents; and
said second set of entities in the massively multiplayer online game comprises characters and equipment in said massively multiplayer online game.

7. The method of claim 1 wherein the said first set of physical entities comprises optimization constraints, and said first set of entities in a massively multiplayer online game comprises characters and equipment in said massively multiplayer online game.

8. A computer program product embodied in a machine-readable medium comprising programming for modeling computationally complex problems comprising programming instructions for:
mapping a first set of physical entities to a first set of entities in a massively multiplayer online game;
mapping a second set of physical entities to a second set of entities in the massively multiplayer online game, wherein each player in the massively multiplayer online game manipulate members of the second set of entities to interact with the first set of entities in accordance with a quest defined in the massively multiplayer online game;
identifying a subset of members of the second set of physical entities corresponding to members of the second set of entities in the massively multiplayer online game having an outcome exceeding a preselected outcome; and
sending results of the quest and the identified subset of members of the second set of physical entities to a remote data processing system for analysis.

9. The computer program product of claim 8 further comprising programming instructions for logging each interaction of the members of the first and second sets in response to player manipulations and corresponding outcomes of said quest of each of the interactions.

10. The computer program product of claim 9 wherein said subset of members of the second set of physical entities comprises a sequence of second entities selected from an output of said logging step, and wherein a physical model problem solution comprises said sequence of second entities.

11. The computer program product of claim 10 wherein a set of transitions between members of said sequence of said second entities comprises an algorithm for said physical model problem solution.

12. The computer program product of claim 8 wherein said subset of members of the second set of physical entities defines a set of a set of experimental protocols for testing against a subset of said first set of physical entities wherein said subset of said first set of physical entities comprises an inverse mapping of members of the second set of entities in the massively multiplayer online game having an outcome exceeding a preselected outcome.

13. The computer program product of claim 12 wherein:
said first set of physical entities comprises pathogenic organisms;
said first set of entities in a massively multiplayer online game comprises antagonists in said massively multiplayer online game;
said second set of physical entities comprises pharmaceutical agents; and
said second set of entities in the massively multiplayer online game comprises characters and equipment in said massively multiplayer online game.

14. The computer program product of claim 8 wherein said first set of physical entities comprises optimization constraints, said first set of entities in a massively multiplayer online game comprises characters and equipment in said massively multiplayer online game.

15. A data processing system for modeling computationally complex problems comprising:
circuitry operable for mapping a first set of physical entities to a first set of entities in a massively multiplayer online game;
circuitry operable for mapping a second set of physical entities to a second set of entities in the massively multiplayer online game, wherein each player in the massively multiplayer online game manipulate members of the second set of entities to interact with the first set of entities in accordance with a quest defined in the massively multiplayer online game;
circuitry operable for identifying a subset of members of the second set of physical entities corresponding to members of the second set of entities in the massively multiplayer online game having an outcome exceeding a preselected outcome; and
sending results of the quest and the identified subset of members of the second set of physical entities to a remote data processing system for analysis.

16. The data processing system of claim 15 further comprising circuitry operable for logging each interaction of the members of the first and second sets in response to player manipulations and corresponding outcomes of said quest of each of the interactions.

17. The data processing of claim 16 wherein said subset of members of the second set of physical entities comprises a sequence of second entities selected from an output of said logging step, and wherein a physical model problem solution comprises said sequence of second entities.

18. The data processing system of claim 17 wherein a set of transitions between members of said sequence of said second entities comprises an algorithm for said physical model problem solution.

19. The data processing system of claim 16 wherein said subset of members of the second set of physical entities defines a set of a set of experimental protocols for testing against a subset of said first set of physical entities wherein said subset of said first set of physical entities comprises an inverse mapping of members of the second set of entities in the massively multiplayer online game having an outcome exceeding a preselected outcome.

20. The data processing system of claim 19 wherein:
said first set of physical entities comprises pathogenic organisms;
said first set of entities in a massively multiplayer online game comprises antagonists in said massively multiplayer online game;
said second set of physical entities comprises pharmaceutical agents; and
said second set of entities in the massively multiplayer online game comprises characters and equipment in said massively multiplayer online game.

21. The data processing system of claim 15 wherein said first set of physical entities comprises optimization constraints, and said first set of entities in a massively multiplayer online game comprises characters and equipment in said massively multiplayer online game.
